(19) United States
(12) Patent Application Publication
(10) Pub. No.: US 2003/0186195 A1
(43) Pub. Date: Oct. 2, 2003

(54) Hand-held medical/dental tool

(75) Inventors: Christopher John Comfort, Cupertino, CA (US); Theodore R. Kucklick, Los Gatos, CA (US)

Correspondence Address: CHRISTOPHER J. COMFORT, DDS, 333 W. EL CAMINO REAL, SUITE 290, SUNNYVALE, CA, 94087, US

(73) Assignee: Comfort Biomedical, Inc., Sunnyvale, CA (US)

(21) Appl. No.: 10/141,309

(22) Filed: May 7, 2002

Related U.S. Application Data
(63) Continuation-in-part of application No. 10/114,638, filed on Apr. 2, 2002.

(51) Int. Cl. A61C 3/08; A61C 3/00

(52) U.S. Cl. 433/164; 433/147

(57) ABSTRACT

A hand held tool for placing and shaping dental resin composites and the like has various interchangeable tips attached to a handle that allow for specific use and geometries associated with tooth surfaces, hard and soft tissues, and the placement of medicaments or irrigation of periodontal tissues. Individual tips may have geometries in three dimensions that coordinate with specific tooth surface analogues that allow a dentist to place and shape restorative materials on the surfaces of teeth. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### RELATED APPLICATIONS

This is a continuation-in-part (CIP) application of application Ser. No. 10/114,638, filed Apr. 4, 2002, and entitled, “HAND-HELD MEDICAL/DENTAL TOOL”, which is assigned to the assignee of the present CIP application.

### FIELD OF THE INVENTION

The present invention relates to the field of dental or medical tools. More specifically, to hand-held dental or medical instruments.

### BACKGROUND OF THE INVENTION

There are numerous dental and medical instruments configured to be hand-held by a practitioner. These tools are generally designed for specific dental and medical applications. Usually these tools consist of some sort of handle or body, with a specialized tip coupled or integrally formed with the end of the body. By way of example, U.S. Pat. No. 6,206,698 discloses a hand-held dental instrument for use in condensing and packing soft composite filling material. Other examples of hand-held tools for medical and dental applications include U.S. Pat. No. 5,820,368, which teaches a disposable applicator for forming and retaining an orthodontic attachment; and U.S. Pat. No. 6,042,378, which discloses a dental or medical instrument having a body with a textured gripping surface that has minimal microbial contaminant retention.

Although the dental/medical instruments described above generally achieve satisfactory results for their intended uses, there is still an unsatisfied need for hand-held medical and dental tools designed for other applications.

### BRIEF DESCRIPTION OF THE DRAWINGS

The present invention is illustrated by way of example, and not limitation, in the figures of the accompanying drawings, wherein:

FIG. 1 is a perspective view of the hand-held tool of one embodiment of the present invention.

FIGS. 2A & 2B illustrate an attachment structure for attaching tip members in accordance with the present invention.

FIGS. 3-18 illustrate a variety of tip members having different geometries.

FIG. 19 is a side view of a specialized handle end/tip member combination useful for curing of resin composite materials in accordance with yet another embodiment of the present invention.

FIG. 20 is a side view of a tip member configured for delivery of material to a distal end in accordance with another embodiment of the present invention.

FIG. 21 is a side view of an alternative handle end/tip member combination utilized for curing composite materials in accordance with the present invention.

FIG. 22 is a perspective view of an alternative embodiment of the hand-held tool according to the present invention.

### DETAILED DESCRIPTION

A hand-held tool is described for intra-oral use with dental patients and/or for specific medical uses. In one implementation, the hand-held tool of the present invention is useful for the placement and shaping of dental materials, including resin composites. In other implementations, the described hand-held tool may also be utilized for the delivery and/or shaping of biomorphic materials used in surgical applications such as bone augmentation. In the following description, numerous specific details are set forth, such as material types, specific shapes, structural features, etc., in order to provide a thorough understanding of the present invention. Practitioners having ordinary skill in the dental and medical arts will understand that the invention may be practiced without many of these details. In other instances, well-known elements, techniques, and processing steps have not been described in detail to avoid obscuring the invention.

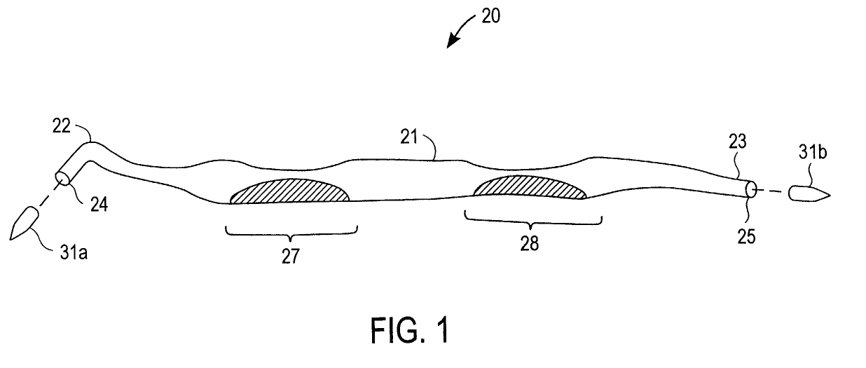

FIG. 1 is an exploded perspective view of a hand-held tool 20 in accordance with one embodiment of the present invention. (It should be understood that the elements in the figures are representational, and are not drawn to scale in the interest of clarity.) Tool 20 comprises a handle or body 21 formed of a rigid material such as plastic, nylon, metal, rubber, or the like in the shape of a shaft. Handle 21 has respective first and second ends 22 and 23, each having a corresponding attachment point 24 and 25, respectively. The handle may optionally be formed with one or more triangulated gripping areas (e.g., areas 27 & 28) for precision handling by a practitioner. Other areas or surface treatments that provide for enhanced gripping may also be included. Attachment points 24 and 25 at each of the working ends are configured to accept any one of a variety of tip members 31. For instance, in the exploded view of FIG. 1, a tip member 31a is shown fitting into attachment point 24, and another tip member 31b is shown fitting into attachment point 25. In this particular example, the attachment points 24 and 25 comprise openings in the respective ends 22 & 23.

It should be understood that the hand-held tool of the present invention could be fabricated to accommodate only one, rather than two, tip member attachments. Additionally, although end 22 is shown curved at a 45-degree angle, and end 23 configured with a straight, 180-degree angle (both with respect to the longitudinal axis of handle 21), other embodiments may be configured with a variety of other angles and/or angle combinations. For example, both ends 22 & 23 may be configured with no angle (i.e., straight), or both having the same or different angles.

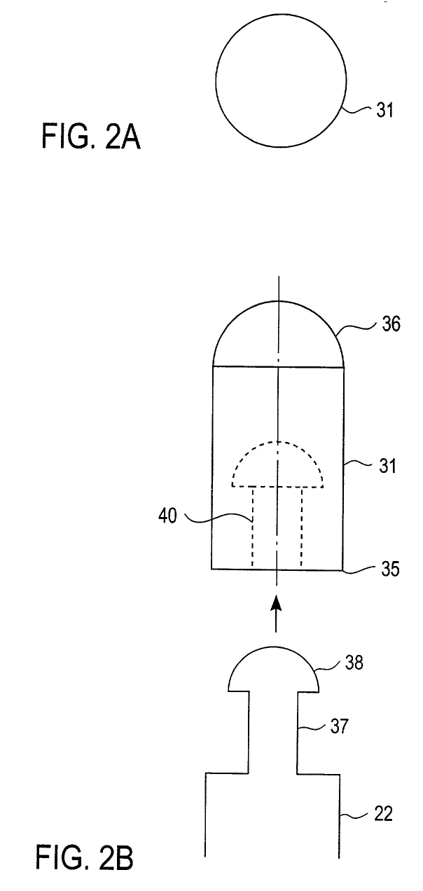

Tip members 31 may have a variety of specific geometries adapted for clinical use in dental hard tissue or teeth oriented procedures, for use in periodontal procedures, for use in oral surgery procedures, and for use in illumination and photo polymerization. In certain medical applications, tip members 31 may be configured for use in facial plastic surgery, laproscopic, minimally invasive surgical procedures, or for delivery and/or shaping of bone augmentation materials. For dental applications, tip members 31 may have specific geometries that correspond to tooth surfaces, and/or that facilitate the placement and/or subsequent shaping of resin composite materials. Various specific shapes are illustrated in FIGS. 2-18 and are discussed in more detail below.

In one embodiment, tip members 31 are made of an elastomeric/pvc compound that has properties of softness and elasticity. For certain applications, tip members 31 are made of a material that additionally provides a non-sticky surface. By way of example, tip members 31 may be formed of resilient silicone, such as Medical Grade Silastic ETR™ Elastomers Q7-4735 and Q7-4750 available from Dow Corning. Other materials having similar elastomeric properties may also be used.

In another embodiment, tip members 31 comprise a material that exhibits low surface energy (e.g., less than 2). A preferred material is any thermoplastic elastomer that exhibits a surface energy lower than that of the dental substrate, thereby causing the dental composite to adhere preferentially to the dental substrate. (In this context, the term “dental substrate” is synonymous with a tooth, crown, bridge, etc.)

The surface energy across an interface or the surface tension at the interface is a measure of the energy required to form a unit area of new surface at the interface. The intermolecular bonds or cohesive forces between the molecules of a liquid cause surface tension. When the liquid encounters another substance, there is usually an attraction between the two materials. The adhesive forces between the liquid and the second substance will compete against the cohesive forces of the liquid. Liquids with weak cohesive bonds and a strong attraction to another material (or the desire to create adhesive bonds) will tend to spread over the second material. Liquids with strong cohesive bonds and weaker adhesive forces will tend to bead-up or form a droplet when in contact with the second material. At the composite-dental substrate surface interface, if the molecules of the liquid composite material have a stronger attraction to the molecules of the solid surface (i.e., a dental substrate) than to each other (the adhesive forces are stronger than the cohesive forces), then wetting of the surface occurs. Alternately, if the liquid molecules are more strongly attracted to each other and not the molecules of the solid surface (the cohesive forces are stronger than the adhesive forces), then the liquid beads-up and does not wet the surface of the part. Wetting ability of a liquid is a function of the surface energies of the solid-gas interface, the liquid-gas interface, and the solid-liquid interface.

By utilizing a material that exhibits low surface energy, the dental composite adheres preferentially to the tooth and releases from the tip member. Materials in this class include, but are not limited to, thermoplastic or thermoset materials. The materials include neoprene rubbers, olefin thermoplastic elastomers (TPE's) urethanes, butadine-styrene TPE's , acrylic-styrene copolymers, ABS and ABS alloys, LDPE and HMWPE (polyethylenes), styrene acrylonitriles (SAN) Polyetherester TPE, acetals, Polyarylamide, TFE, PTFE and EPTFE and other elastomers with a hardness between 10 Shore A and 40 Shore D. In one particular embodiment, Tygon™ brand urethane may be used.

TPE tip members 31 may also be color coded according to durometer and tip geometry in accordance with the present invention.

In a particular embodiment, tip members 31 comprise an injection-moldable thermoplastic elastomeric (TPE) material having a surface energy lower than that of the dental substrate. By way of example, one such material is commercially available from Colorite Corporation, and is known as Flexchem 4051 injection moldable PVC, 40 Shore A hardness, clear. When the tip member material has a surface energy lower than that of the dental substrate, it releases as it peels away from the placed dental composite, thereby providing a non-sticking mechanism. This non-sticking mechanism causes the dental composite to adhere preferentially to the dental substrate and release from the dental instrument. Use of tip members 31 formed of a TPE, advantageously allows the dental tool of the present invention to be utilized with a class of highly sticky dental composites that are not practical to place and sculpt with existing metal tools. Such sticky dental composite materials may be formulated to promote superior adhesion to dental substrates, and enhanced usability by dental practitioners.

Non-sticking material properties are often derived from the porosity of the material. For example, other suitable materials for use as tip members in accordance with the present invention include porous TPE materials such as Kraton , Satoprene™, Expanded PTFE (Teflon™), or a porous thermoset (porous silicone).

Tip members 31 may also be made of elastomeric material that have “Gumby-like” properties of pliability that allow the tip material to be bent or otherwise formed to a specific shape or geometry. Once formed to a specific shape, i.e., corresponding with the pan-morphological geometry of a tooth, that shape is maintained by the Gumby-like property of the material.

Generally speaking, tip members 31 should comprise a material that is generally clean for dental use and sterile for medical use. The dental use includes procedures associated with the shaping of composite resins upon tooth structure. In dental applications, tip member 31 is used to place an amount of resin composite material in or against a tooth. The specific geometry of tip member 31 may be selected based on the particular shape of the tooth under repair. The specific geometry of tip member 31 may also be selected to facilitate shaping of the resin composite material. In use, the resin composite material may be made to adhere to the tooth using conventional bonding techniques.

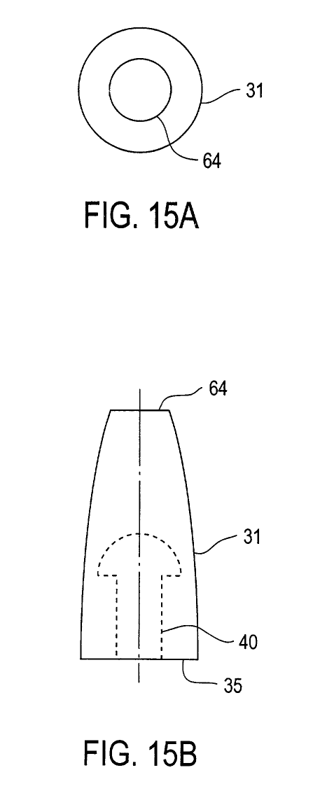

In another embodiment, tip members 31 may be used to deliver and shape materials designed to augment defects in bone. These may include such materials as Pepgen-15®, Bio-oss®, or other bone augmentation materials. The bone augmentation material may be delivered through a canula disposed within or alongside the tip member (see FIG. 15). Alternatively, a delivery tube may simply be attached to some portion of handle 21 and directed in a manner such that the material is delivered to the working area, i.e., near the distal end of tip member 31.

In the embodiment of FIG. 1, tip members 31 may be secured to ends 22 and 23 using a variety of well-known attachment methods, such as press-fitting, gluing, helical threading, sliding compression ring, etc. Preferably, tip members 31 are disposable and are secured to the ends 22 and 23 of handle 21 in a removable manner that allows for replacement with each successive use or application. A removable attachment also allows for interchangeability of different tip members.

The embodiment of FIG. 1 shows tip members 31 being attached in a female/male mated relationship in which the tip members 31 may simply be press-fit into attachment points 24 & 25, which, in this example, comprise cylindrical openings. A close, tight fit between the cylindrically shaped opening and the insertion end of tip member 31 provides a secure attachment to handle 21. In one implementation tip members 31 have a diameter ranging from 1 mm to 10 mm. It is appreciated that other embodiments may have different shaped openings, or may utilize different tip member attachment methods.

To facilitate attachment to the handle, the tip members 31 may be formed of an elastomeric material having dual durametric elasticity; that is, with two different levels of hardness. For instance, the part of the tip member that fits with the attachment point of the handle may be made harder than the distal end portion of the tip member used in placing and shaping the medical/dental materials in order to facilitate secure attachment of the tip member to the end of the handle.

FIG. 22 is an perspective view of an alternative embodiment in which end 22 of handle 21 is formed with a semicircular flange 26 that is useful in cutting composite resin material into one or more material segments or portions as the material is being delivered. In other words, a practitioner may use flange 26 to cut a portion of resin material from a delivery tube or syringe. Once the resin material is deposited on the flat surface of flange 26, it may be administered to a patient's tooth and then shaped using an appropriate tip member fitted to attachment point 24 (or 25).

FIG. 22 also shows another option in which a specialized tip 29 is fitted to attachment point 25 at end 23 of handle 21. Tip 29 comprises a rigid material such as Lexan™ that may be advantageously formed to a shape (e.g., with a triangulated endpoint) that enables it to perform a cutting function similar to flange 26. That is, instead of, or in addition to, flange 26, the hand-held tool of the present invention may be fitted with a specialized tip 29 that may be used to cut resin composite material.

FIGS. 2-18 illustrate various exemplary geometries for tip members 31. It should be understood that the present invention is not limited to these specific geometries. Furthermore, each of the geometries shown in FIGS. 2-18 may be used in medical/dental surgical procedures for the analogue of tissue augmentation.

FIGS. 2A & 2B show respective top and side views of a cylindrical tip member having a rounded hemispherical distal end 36, which may be used to place and spread resin composite material within a cavity of a tooth or a bone, or against the surface of either. When restorative materials are placed into the preparation or cavity, a vertical and circumferential spread is obtained using this tip geometry.

FIG. 2B also illustrates a male/female attachment arrangement in which handle end 22 includes a peg 37 having an enlarged, rounded head 38. Tip member 31 is fabricated with a correspondingly shaped interior orifice or opening 40 at insertion end 35. To attach tip member 31 to handle end 22, head 38 is pushed into opening 40 until a mated relationship is established. Note that the elastomeric property of tip member 31 allows the insertion end 35 of tip member 31 to expand to accept peg 37. This attachment method also facilitates quick removal and replacement of the tip member. Old or used tip members may be pulled off for disposal, with a replacement tip member simply being pushed or popped on the peg 37 located at the end of the handle.

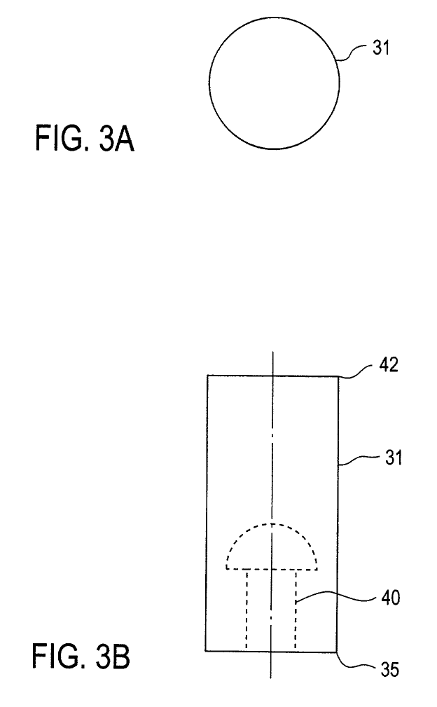

FIGS. 3A & 3B show a cylindrical tip member 31 having a flat, blunt distal end 42. This tip member geometry may be used for occlusal force tests and seating of restorations. Another clinical use for this embodiment is in the packing of material into large defects. For example, resin composite material in an uncured state can be pushed into a cavity providing intimate adaptation of the resin to the surrounding tooth structure. For this clinical application the tip member may be fabricated from a material having a higher elasticity.

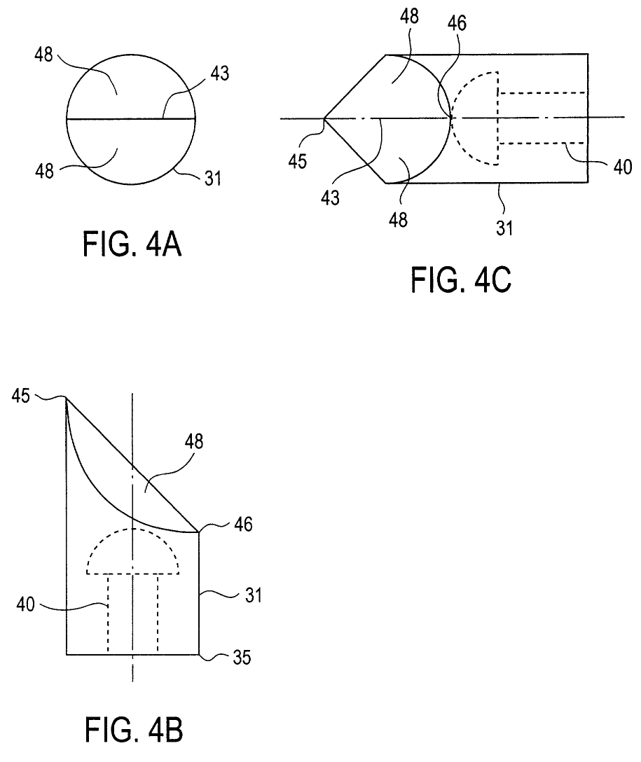

FIGS. 4A-4C show a top view and two side views of another cylindrically shaped tip member 31 having an angled chisel distal end geometry. Tip member 31 is cut at an angle of about 45 degrees along a central diameter line 43 that extends from a distal endpoint 45 to a point 46 nearer to insertion end 35. The side surfaces 48 recede away from the central diameter line 45 at an angle of between 30 to 55 degrees. Those skilled in the dental arts will appreciate that this tip member geometry may be used to develop embrasures that exist naturally between teeth and are determined in part by the line angles associated with individual teeth. The distal end may also be used to remove excess luting resins or cements from restorations. The edge created by the 45 degree cut may also be used for the development of surfaces and internal anatomy of restored teeth. Specifically, when the composite resin is in its plastic form prior to photo polymerization, the tip may be used in a light stroking fashion from the tooth's gingival to incisal edge. This movement deforms the resin to the desired shape.

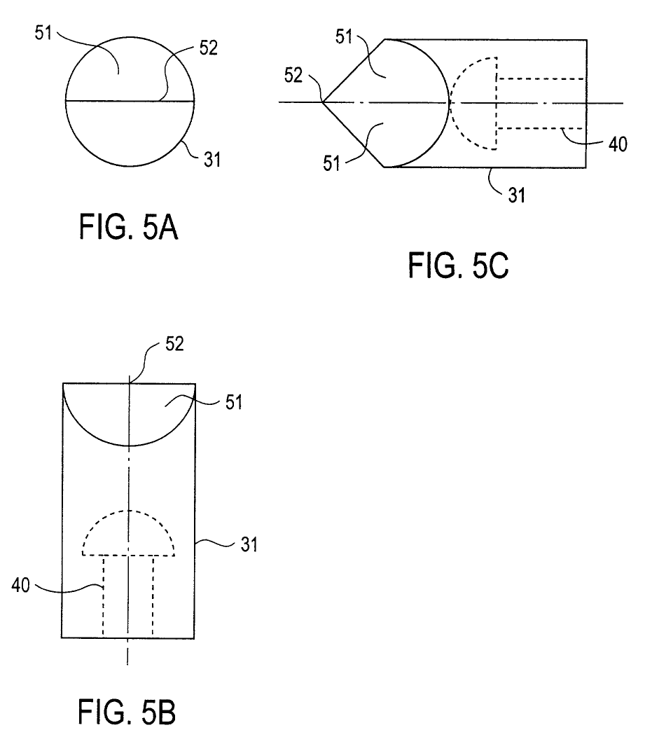

FIGS. 5A-5C illustrate still another embodiment of a cylindrically shaped tip member 31 having approximate triangular shaped distal end geometry. The particular tip member geometry shown in FIGS. 5A-5C is useful as a spreader of resin composite materials. The tip has a horizontal cut along diameter line 52 of the cylinder, with receding side surfaces 51 being angled in a range of 12 to 45 degrees. These side surfaces 51 may be used to shape, flatten, or spread the resin composite material.

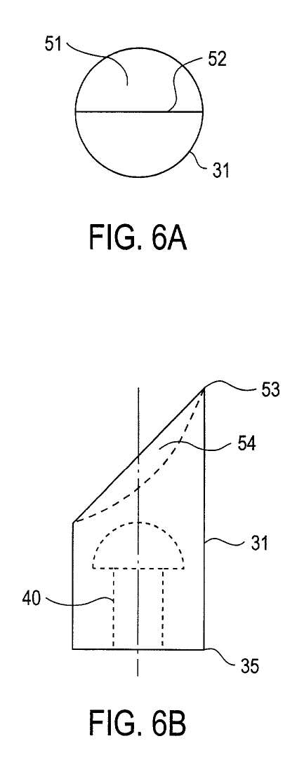

FIGS. 6A and 6B show a cylindrical tip member with an angled end geometry. The distal end 53 has an angle of about 45 degrees with a parabolic surface 54. The tip member 31 has a cylindrical diameter ranging from 2 mm to about 10 mm. Those skilled in the dental arts will appreciate that the embodiment of FIGS. 6A & 6B is useful in shaping labial surfaces of teeth and larger root surfaces. It helps to create spherical contours associated with the emergence profiles of teeth and overall labial contours. In one embodiment, the parabolic surface 54 has a depression that is 2 mm deep at its center.

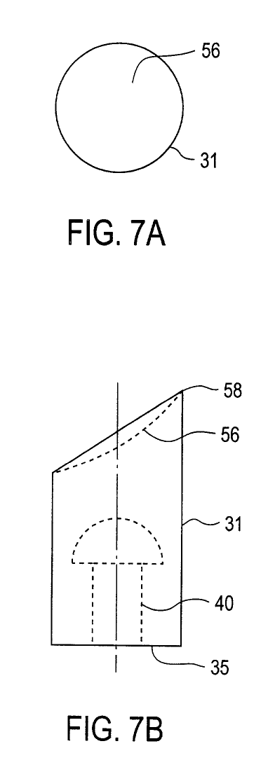

Another embodiment of this parabola geometry is shown in FIGS. 7A & 7B, which has a distal end 58 having an angle ranging from 18 to 30 degrees and a less deep (e.g., 1 mm) parabola surface 56. The embodiment of FIGS. 7A & 7B is useful in the shaping of resins in larger teeth.

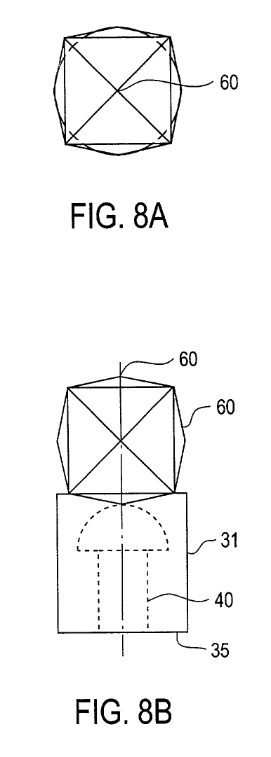

FIGS. 8A & 8B show respective top and side views of a tip member 31 having a cuboidal geometry. Each of the five sides of the distal end of the tip member includes a pyramidal shape 60 with surface angles ranging from 91 to 180 degrees. The tip member of FIGS. 8A & 8B has an analogue in the metallic instrumentation field know as an acorn burnisher. Those skilled in the art will recognize its use in shaping composite resins placed into the occlusal surfaces of molars and bicuspids. This tip member geometry is also useful for pressure seating of restorations that are either luted or adhered to tooth surfaces.

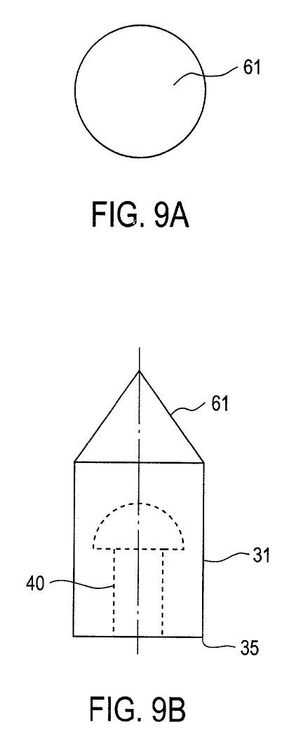

FIGS. 9A & 9B show respective top and side views of a tip member 31 having a conical end surface 61. The angle of the conical tip may range from 30 to 60 degrees. This tip member is useful in packing composite resins into tooth preparations. In addition, the conical shape may be used to remove excess cement from the seating of restorations. The conical surface 61 permits the lateral and vertical spread of material into any defect.

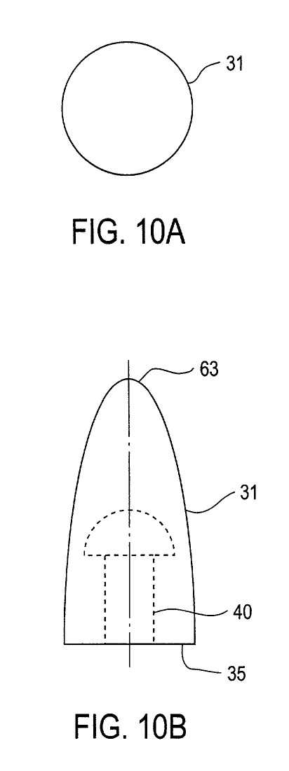

FIGS. 10A & 10B is a tip member 31 having a distal end with a rounded convex parabola geometry 63. The diameter may range from 1 to 5 mm. Those skilled in the art will recognize its use for packing and shaping posterior molar composite resin restorations. A tip member 31 having a parabolic shape, but with a blunted end 64 is also shown in FIGS. 15A & 15B.

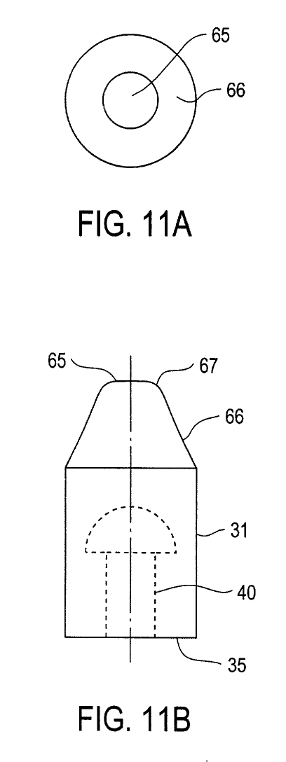

FIGS. 11A & 11B illustrate top and side views, respectively, of a tip member 31 having blunted cone geometry 66. This tip member has two diameters. The distal end 65 has a diameter less than that of the overall cylindrical portion of the tip member. Distal end 65 includes a rounded interface 67 disposed between end 65 and the end of conical surface 66. The tip member of FIGS. 11A & 11B is useful in placement, shaping and adaptation of material in both Class 1 and Class 2 preparation designs. It may also be used as a wedge in the Class 2 preparation designs to ensure tight interproximal contact between adjacent teeth.

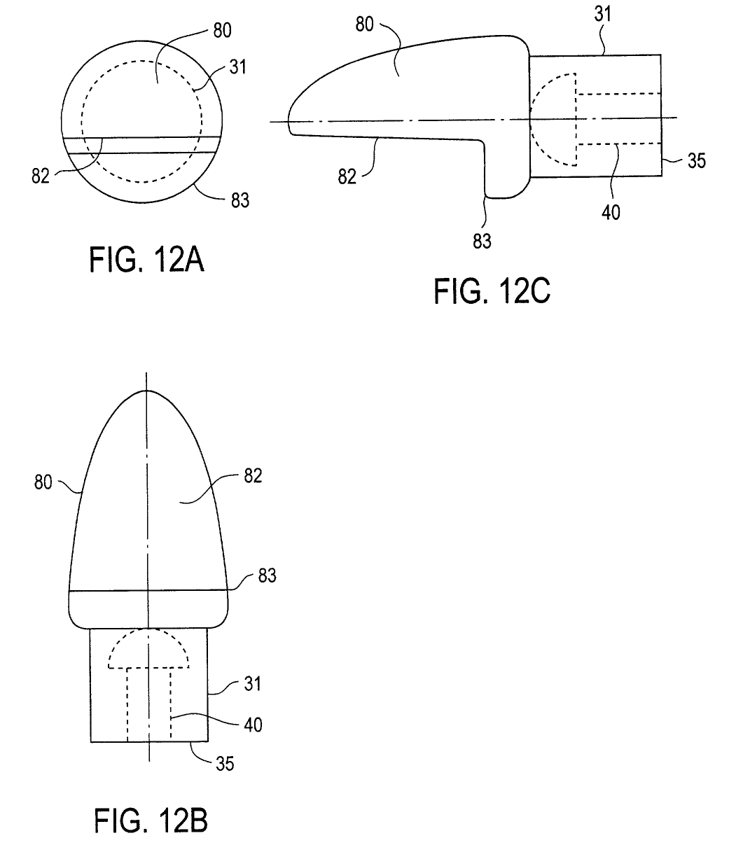

FIGS. 12A-12C illustrate a top and two side views, respectively, of a tip member 31 having geometry used for matricing the lingual surfaces of teeth characterized as having class 4 lesions or defect. The tip has a body portion 80 that is relatively hard to provide the rigidity that allows for packing of composite material against the flat surface 82. Surface 82 may have a geometry that conforms to a lingual surface of an anterior tooth or the missing side of a bicuspid or molar tooth. A step 83 is disposed orthogonal to flat surface 82. Step 83 permits leveling of the tip member 31 with an incisal or occlusal edge of a tooth. Surface 82 may be convex or concave.

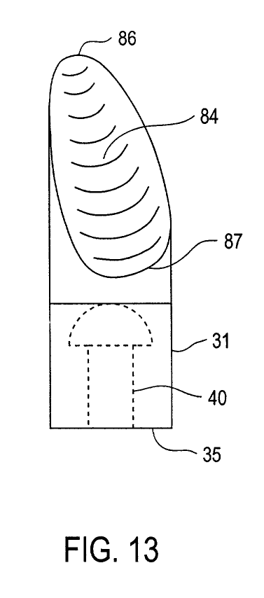

FIG. 13 shows a tip member 31 that is pear or tear dropped shaped. It has a parabolic depression 84 and a curvature at its distal end 86 more acute than the curvature at its proximal end 87. Those skilled in the art will appreciate that the embodiment of FIG. 13 is useful in the development of contours of teeth. The tip member of FIG. 13 can place and/or shape composite resins to more precisely adapt the material to acute curvatures associated with certain tooth forms, root surfaces, and what is know in the art as class 5 restorations.

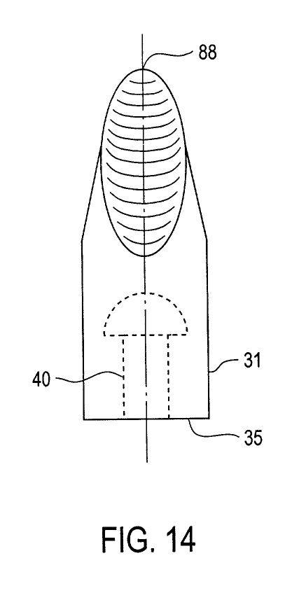

An additional embodiment of this tip member geometry is more elongated, and is shown in the side view of FIGS. 14. The angle of curvature 88 is the same at both the proximal and distal end of the depression. The elongated parabolic shape is depressed by more than 1 mm. Those skilled in the art will appreciate that this tip geometry is ideally suited for creating restorations whereby the clinician restores longer, exposed root surfaces, or even bone structures of the maxilla associated with canaine prominences.

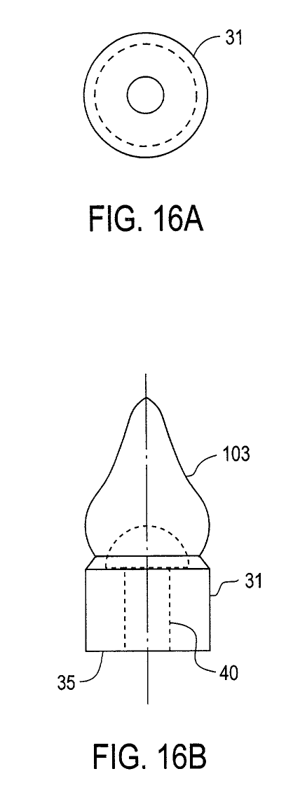

FIGS. 16A & 16B show top and side views of a bulbous nipple geometry 103 at the distal end of a tip member 31.

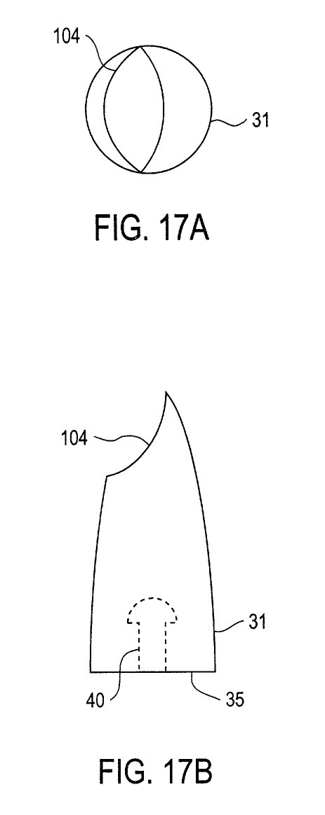

FIGS. 17A & 17B are top and side views of a tip member 31 with a parabolic shaped body with a concave, spoon-shaped angled depression 104 located at the distal end of the tip member.

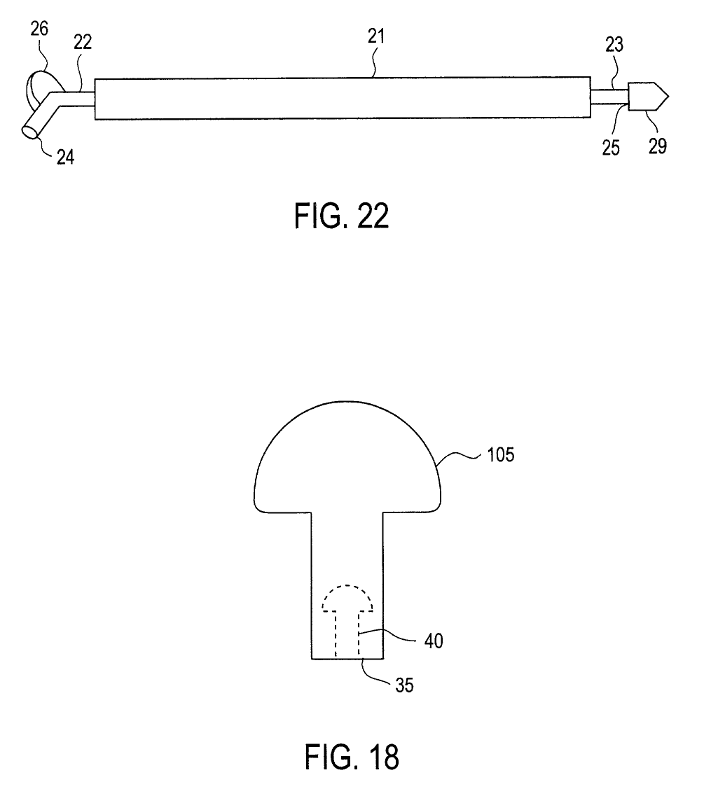

FIG. 18 is a side view of a tip member 31 with a flat, fan-shaped distal end 105. Practitioners will appreciate that the fan-shaped surface may be placed in back of or adjacent to a tooth to act as a dam for the resin composite material. In certain applications it may be desirable to make the fan-shaped distal end 105 of a Gumby-like elastomeric material that allows bending of the flat fan-shaped surface to the contours of a tooth.

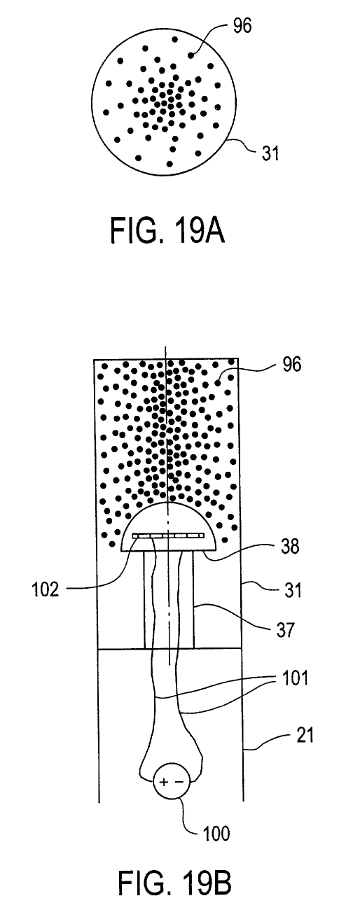

FIGS. 19A and 19B show respective top and side views of another embodiment of a tip member 31 made of an optically transparent material. The embodiment of FIGS. 19A & 19B is useful for curing resin composites. This tip may also be used to pack composite materials. LED array 102 provides optical radiation at an appropriate frequency transmitted through the optical grade material of tip member 31. Curing of the resin composite occurs when the distal end of tip member 31 is placed near or against the composite material and LED array 102 are energized by application of electrical current supplied by a power source 100. Note that the internal geometry of tip member 31 of FIG. 19 may be adapted to provide a lens effect of an ideal angle. To facilitate turning LED array 102 on and off, a finger-activated switch may be incorporated into handle 21.

In one particular embodiment, the optically transparent material may optionally be embedded with micro-reflective particles 96. The particles function to focus, scatter or diffuse light emitted from a light source, such as light-emitting diode (LED) array 102. In this example, head 38 of peg 37 includes an embedded LED array 102. Head 38 comprises a clear, rigid material, such as a plastic material that is transparent to the characteristic wavelength range (e.g., 400-550 nm) of LED array 102. Other implementations may utilize one or more discrete LEDs. LED array 102 is coupled to a power source 100 via wires 101, which are shown likewise embedded in peg 37.

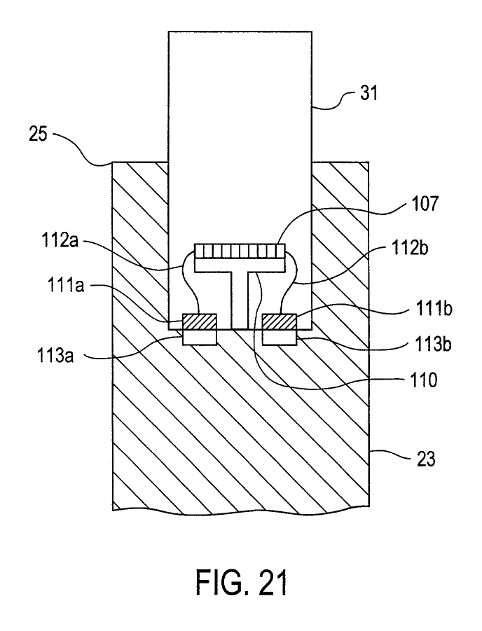

In another embodiment shown in FIG. 21, tip member 31 may incorporate electrical contacts such as powder contacts 111a & 111b located on the proximate end of tip member 31. FIG. 21 illustrates a press-fit attachment scheme in which the proximate end of tip member 31 conformably fits into attachment point 25 at end 23 of the handle. In this example attachment point 25 comprises a cylindrical opening that accepts tip member 31 in a snug, tight-fitting relationship. Electrical contacts 113a & 113b are disposed in the base of the opening at locations that align and correspond to contacts 111a & 111b. Contacts 113a & 113b are coupled to a power source (not shown) that may either be located within the handle or remotely.

An LED array 107 is shown embedded within the optically transparent material comprising tip member 31. LED array 107 may be suspended within the optically transparent material, or supported by a base 110, which is shown in FIG. 21 having a pedestal structure. LED array 107 is connected to contacts 111a & 111b via wires 112a & 112b. Note that in this embodiment, other variations or structures for providing good electrical contact may be provided. For example, contacts 110 may be raised within the opening. Other variations may include locating the contacts along the sidewalls of tip member 31 and opening 25.

Another possibility is to have the light source attached to an exterior surface of the handle in a way that directs the resin curing radiation at the distal end of tip member 31. In other words, the present invention contemplates three possible locations for the light source (e.g., an LED array) used to cure the resin composite material: The light source may be incorporated into the end of the handle (as shown in FIG. 19); it may be incorporated into the tip member 31 (as shown in FIG. 21); or, the light curing source may be provided by external attachment to the body of the handle (not shown).

In either case, power source 100 may either be embedded within the body 21 of the hand-held tool of the present invention, or be remotely located. In the case where power source 100 is incorporated in the handle, one possibility is to include a battery with a finger-activated switch that allows the practitioner to energize the curing radiation and control the curing time precisely. Additional timer or control circuitry may also be employed to more precisely control the duration and energy of the applied radiation so as to provide optimal curing of the resin composite material.

With respect to the embodiments described above in conjunction with FIGS. 19 and 21, it should be understood that tip members 31 may comprise any of the specific geometries disclosed in FIGS. 2-18, or other geometries, that facilitate placement and/or shaping of dental restorative materials. That is, in addition to being optically transparent to the curing radiation, the tip members may also be formed of an elastomeric material useful to perform the procedures previously described. In such cases, the practitioner may use one or more tip members 31 for placing and/or shaping the dental restorative material in or on the tooth under repair, and then energize the light source of the hand-held tool to cure the material. In other cases, the dentist may replace the tip member(s) used to place and shape the material with another tip member 31 (such as that shown in FIG. 19) in order to effectuate curing.

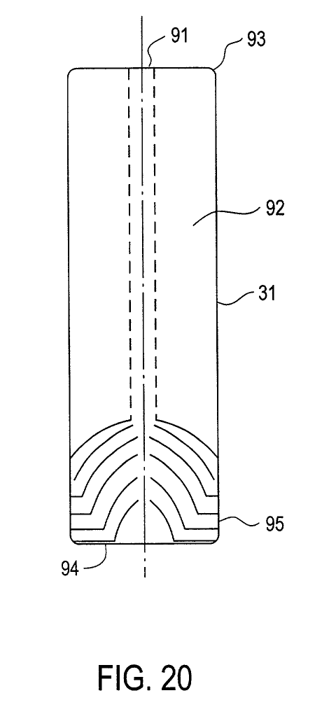

FIG. 20 illustrates a tip member 31 that is rectangular in form, and has a delivery canula 91 for irrigation solutions and/or medicaments typically placed within the sulcus or periodontal pockets of teeth. It may also be used for the delivery of flowable composite resins, such as TetricFlow™. Another possible medical application is for the delivery of bone augmentation materials. Canula 91 is surrounded by elastomeric material that forms a body 92 with rounded edges 93.

This embodiment may optionally include a syringe-type attachment 94 with threads 95 that allow for attachment to a correspondingly threaded end of handle 21. Attachment 94 may have a significantly higher elasticity to allow for ease of placement in or removal from a syringe. The tip member 31 of FIG. 15 may also be threadably secured to an end of handle body 21. In certain embodiments, handle 21 may include a reservoir for holding the fluid material, solution, and/or medicaments.

Delivery of the fluid material to the exit port at the distal end of the tip member may be effectuated by a finger-operated pump mechanism incorporated into the handle. One possibility is to provide the reservoir as a rubber bulb on or in the handle—the practitioner, to provide pressure delivery of the fluid material or solution to the tip member, may simply squeeze the bulb. Other implementations may utilized a conventional battery-powered micro-pump mechanism. Alternatively, a remotely located pump fluidly coupled to the attachment point at the end of the handle may be utilized so as to similarly deliver the fluid material through the canula from the proximate end to the exit port 91 located at the distal end of the tip member 31. The overall dimensions may range from about 1 mm to 4 mm with a canula internal diameter ranging from 0.5 mm to 2 mm.

We claim:

1. A hand-held dental tool comprising:
a handle having a first end;
a tip member comprised of a thermoplastic elastomer (TPE) material having a surface energy lower than that of a dental substrate, the tip member having a proximate end and a distal end, the distal end having a geometry that facilitates placement and/or shaping of a dental restorative material in or against the dental substrate

2. The hand-held dental tool of claim 1 further comprising:
means for removable attachment of the proximate end of the tip member to the first end of the handle.

3. The hand-held dental tool of claim 1 wherein the dental substrate comprises a tooth.

4. The hand-held dental tool of claim 1 wherein the dental restorative material comprises a composite material.

5. The hand-held dental tool of claim 1 wherein the tip member includes a canula that extends from the proximate end to the distal end.

6. A hand-held dental tool, comprising:
a handle having at least one working end; and
a tip member removably mounted to the at least one working end, the tip member being comprised of a thermoplastic elastomer (TPE) material having a surface energy sufficient to cause a dental restorative material placed on the tip member to adhere preferentially to a dental substrate when the dental restorative material is placed against a dental substrate.

7. The hand-held dental tool of claim 6 wherein the tip member has a proximate end and a distal end, the proximate end being removably mounted to the at least one working end, and the distal end having a geometry that facilitates placement of the dental restorative material on the dental substrate.

8. The hand-held dental tool of claim 7 wherein the geometry of the tip member is pointed.

9. The hand-held dental tool of claim 7 wherein the geometry of the distal end of the tip member is rounded.

10. The hand-held dental tool of claim 7 wherein the geometry of the distal end of the tip member is blunted.

11. The hand-held dental tool of claim 7 wherein the geometry of the distal end of the tip member is convex.

12. The hand-held dental tool of claim 6 wherein the TPE material comprises a porous TPE material.

13. A hand-held dental tool, comprising:
a handle having at least one working end; and
a tip member removably mounted to the at least one working end, the tip member being comprised of a thermoplastic elastomer (TPE) material having a surface energy sufficient to cause a dental restorative material placed on the tip member to adhere preferentially to a dental substrate when the dental restorative material is placed against a dental substrate.

14. The hand-held dental tool of claim 12 wherein the tip member has a proximate end and a distal end, the proximate end being removably mounted to the at least one working end, and the distal end having a geometry that facilitates placement of the dental restorative material on the dental substrate.

15. The hand-held dental tool of claim 7 wherein the geometry of the tip member is pointed.

16. The hand-held dental tool of claim 7 wherein the geometry of the distal end of the tip member is rounded.

17. The hand-held dental tool of claim 7 wherein the geometry of the distal end of the tip member is blunted.

18. The hand-held dental tool of claim 7 wherein the geometry of the distal end of the tip member is convex.

19. A hand-held dental tool, comprising:
a handle having at least one working end; and
a tip member removably mounted to the at least one working end, the tip member being comprised of a thermoplastic elastomer (TPE) material having a surface energy sufficient to cause a dental composite material placed on the tip member to adhere preferentially to a dental substrate when the dental composite material is placed against a dental substrate, the material also being transparent to radiation having a wavelength sufficient to cure the dental composite material.

20. The hand-held dental tool of claim 19 further comprising a light source disposed in the tip member, the light source providing radiation at the wavelength when energized.

21. The hand-held dental tool of claim 19 further comprising a light source disposed in the working end of the handle, the light source providing radiation at the wavelength when energized.

22. The hand-held dental tool of claim 20 wherein the light source comprises one or more light-emitting diodes (LEDs).

23. The hand-held dental tool of claim 19 further comprising a light source attached to the handle, the light source providing radiation at the wavelength when energized.

24. The hand-held dental tool of claim 19 wherein the wavelength is in a range of 400 to 550 nm.
